(19) United States
(12) Patent Application Publication
(10) Pub. No.: US 2024/0367057 A1
(43) Pub. Date: Nov. 7, 2024

(54) DATA PROCESSING METHOD AND APPARATUS IN VIRTUAL SCENE, DEVICE, STORAGE MEDIUM, AND PROGRAM PRODUCT

(71) Applicant: Tencent Technology (Shenzhen) Company Limited, Shenzhen (CN)

(72) Inventor: Luxin ZHANG, Shenzhen (CN)

(73) Assignee: Tencent Technology (Shenzhen) Company Limited, Shenzhen (CN)

(21) Appl. No.: 18/772,060

(22) Filed: Jul. 12, 2024

Related U.S. Application Data
(63) Continuation of application No. PCT/CN2023/098312, filed on Jun. 5, 2023.

(30) Foreign Application Priority Data
Aug. 18, 2022 (CN) 202210993816.3

(51) Int. Cl. A63F 13/69

(52) U.S. Cl. CPC A63F 13/69

(57) ABSTRACT

In a data processing method, a detection control corresponding to configuration of a virtual object is displayed in a configuration detection interface of a virtual scene. The configuration of the virtual object includes at least two detection categories, and each detection category includes at least one detection item. The configuration of the virtual object in the detection categories is detected when a detection instruction is triggered based on the detection control. Progress indication information of the configuration of the virtual object is displayed. The progress indication information is configured to indicate progress of detecting the configuration of the virtual object in each detection category. A detection result of each detection item of the virtual object is displayed.

### RELATED APPLICATIONS

The present application is a continuation of International Application No. PCT/CN2023/098312, filed Jun. 5, 2023, which claims priority to Chinese Patent Application No. 202210993816.3, filed on Aug. 18, 2022. The entire disclosures of the prior applications are hereby incorporated by reference.

### FIELD OF THE TECHNOLOGY

This disclosure relates to the fields of computer technology virtualization and human-computer interaction technologies, including to a data processing method and apparatus in a virtual scene, a device, a storage medium, and a program product.

### BACKGROUND OF THE DISCLOSURE

With development of computer technologies, an electronic device may implement a richer and more vivid virtual scene. A user may obtain virtualized feelings in visual, auditory, and other sensory aspects in a virtual scene. There are various typical application scenes. For example, in a game scene, a real interaction process between virtual objects can be simulated.

Before interacting with another user based on the virtual object, the user often needs to set assembly of the virtual object (for example, a prop of the virtual object). The assembly of the virtual object may be detected to know whether the current assembly of the user needs to be reset. In the related art, a manner of detecting the assembly of the virtual object has a complex detection procedure and requires a large quantity of users to participate in the detection procedure, resulting in low detection efficiency of the assembly of the virtual object and low utilization of a hardware resource of the electronic device.

### SUMMARY

This disclosure provides a data processing method and apparatus in a virtual scene, an electronic device, a computer-readable storage medium, and a computer program product, to implement one-tap detection on assembly of a virtual object, thereby improving detection efficiency.

Examples of technical solutions are implemented as follows:

An aspect of this disclosure provides a data processing method in a virtual scene. In the method, a detection control corresponding to configuration of a virtual object is displayed in a configuration detection interface of a virtual scene. The configuration of the virtual object includes at least two detection categories, and each detection category includes at least one detection item. The configuration of the virtual object in the detection categories is detected when a detection instruction is triggered based on the detection control. Progress indication information of the configuration of the virtual object is displayed. The progress indication information is configured to indicate progress of detecting the configuration of the virtual object in each detection category. A detection result of each detection item of the virtual object is displayed.

An aspect of this disclosure provides a data processing apparatus in a virtual scene, including processing circuitry is provided. The processing circuitry is configured to display a detection control corresponding to configuration of a virtual object in a configuration detection interface of a virtual scene. The configuration of the virtual object includes at least two detection categories, and each detection category includes at least one detection item. The processing circuitry is configured to detect the configuration of the virtual object in the detection categories when a detection instruction is triggered based on the detection control. The processing circuitry is configured to display progress indication information of the configuration of the virtual object. The progress indication information is configured to indicate progress of detecting the configuration of the virtual object in each detection category. The processing circuitry is configured to display a detection result of each detection item of the virtual object.

An aspect of this disclosure further provides an electronic device. The electronic device includes:
a memory, configured to store computer-executable instructions; and
a processor, configured to implement a data processing method in a virtual scene provided of this disclosure by executing the computer-executable instructions stored in the memory.

An aspect of this disclosure further provides a non-transitory computer-readable storage medium, having computer-executable instructions stored therein, the computer-executable instructions, when executed by a processor, implementing a data processing method in a virtual scene provided in this disclosure.

An aspect of this disclosure further provides a computer program product, including a computer program or computer-executable instructions, the computer program or the computer-executable instructions, when executed by a processor, implementing a data processing method in a virtual scene provided in this disclosure.

In the configuration detection interface, the one-tap detection control corresponding to the configuration of the virtual object is displayed. When the detection instruction triggered based on the one-tap detection control is received, the configuration of the virtual object in the detection categories is automatically and sequentially detected. In addition, the detection result of each detection item of the virtual object in each detection dimension is synchronously displayed along with execution of the detection. In this way, when a user triggers the detection instruction based on the one-tap detection control, one-tap detection on a plurality of detection items of the virtual object in a plurality of detection categories may be implemented. Compared with a complex detection procedure in the related art, detection efficiency of the configuration of the virtual object in the virtual scene is improved, and utilization of a hardware processing resource and a display resource of a device is improved.

### BRIEF DESCRIPTION OF THE DRAWINGS

FIG. 1A to FIG. 1C are schematic diagrams of data processing interfaces in a virtual scene in the related art.

FIG. 2 is a schematic structural diagram of an architecture of a data processing system in a virtual scene according to an aspect of this disclosure.

FIG. 3 is a schematic structural diagram of an electronic device 500 according to an aspect of this disclosure.

FIG. 4 is a schematic flowchart of a data processing method in a virtual scene according to an aspect of this disclosure.

FIG. 5A is a schematic diagram of an assembly detection interface according to an aspect of this disclosure.

FIG. 5B is a schematic diagram of a setting interface for one-tap detection according to an aspect of this disclosure.

FIG. 6 is a schematic diagram of a progress indication of assembly detection according to an aspect of this disclosure.

FIG. 7 is a schematic diagram in which a one-tap detection control is switched to an assembly modification control according to an aspect of this disclosure.

FIG. 8 is a schematic diagram of displaying a detection result of assembly according to an aspect of this disclosure.

FIG. 9 is a schematic diagram of an interface of an assembly auxiliary setting according to an aspect of this disclosure.

FIG. 10 is a schematic diagram of display interfaces of a plurality of abnormal detection items according to an aspect of this disclosure.

FIG. 11A and FIG. 11B each are a schematic diagram of a determining control in a detection interface according to an aspect of this disclosure.

FIG. 12 is a schematic flowchart of a data processing method in a virtual scene according to an aspect of this disclosure.

### DETAILED DESCRIPTION

To make objectives, technical solutions, and advantages of this disclosure clearer, the following describes this disclosure in detail with reference to the accompanying drawings. The described examples are not to be construed as a limitation to this disclosure. All other examples obtained by a person of ordinary skill in the art without creative efforts fall within the protection scope of this disclosure.

In the following descriptions, the terms such as “first/second/third” are merely used to distinguish between similar objects and do not represent a specific order for objects. A specific order or sequence of the objects described by using “first/second/third” may be exchanged if allowed, so that aspects of this disclosure described herein can be implemented in an order other than that illustrated or described herein.

Unless otherwise defined, all technical and scientific terms used in this specification have same meanings as those usually understood by a person skilled in the art of this disclosure. The terms used in this specification are merely for the purpose of describing embodiments of this disclosure, but are not intended to limit this disclosure.

Before describing examples of this disclosure in detail, nouns and terms involved in examples of this disclosure are described. The nouns and terms involved in examples of this disclosure are applicable to the following explanations.
(1) A client is an application running in a terminal to provide various services, for example, a game client, an instant messaging client, or a video playback client.
(2) The term “in response to” is configured for indicating a condition or a state on which to-be-performed operations depend. When the condition or the state on which the operations depend are met, one or more operations may be performed in real time or may be performed with a set delay. Unless otherwise specified, an execution sequence for performing a plurality of operations is not limited.
(3) A virtual scene is a virtual scene displayed (or provided) when the application runs in the terminal. The virtual scene may be a simulation environment of the real world, or may be a semi-simulation and semi-fictional virtual environment, or may be a purely fictional virtual environment. The virtual scene may be any one of a two-dimensional virtual scene, a 2.5-dimensional virtual scene, or a three-dimensional virtual scene. A dimension of the virtual scene is not limited of this disclosure. For example, the virtual scene may include the sky, the land, the ocean, and the like. The land may include environmental elements such as a desert and a city, and a user may control a virtual object to move in the virtual scene. In some embodiments, the virtual scene may be a game, for example, a multiplayer online battle arena (Multiplayer Online Battle Arena, MOBA) game.
(4) Virtual objects are figures of various people and objects that can interact in the virtual scene, or movable objects in the virtual scene. The movable object may be a virtual character, a virtual animal, a cartoon character, or the like, for example, a character or an animal displayed in the virtual scene.
(5) Assembly is assembly or a configuration of the virtual object in the virtual scene, and is configured for indicating assembly information of the virtual object in the virtual scene. The assembly includes at least two assembly dimensions (for example, categories and/or attributes), for example, an object dimension (such as, an arm dimension), a medicine dimension, and a container dimension, and each assembly dimension includes one or more (in other words, at least two) assembly items. For example, the object dimension may include the following assembly items: a prop (for example, an attack prop) of the virtual object, a skill of the virtual object, and a costume of the virtual object. In an aspect, each assembly item may further include a plurality of sub-assembly items. For example, the prop of the virtual object may include the following sub-assembly items: a shooting prop, a throwing prop, and a melee prop.

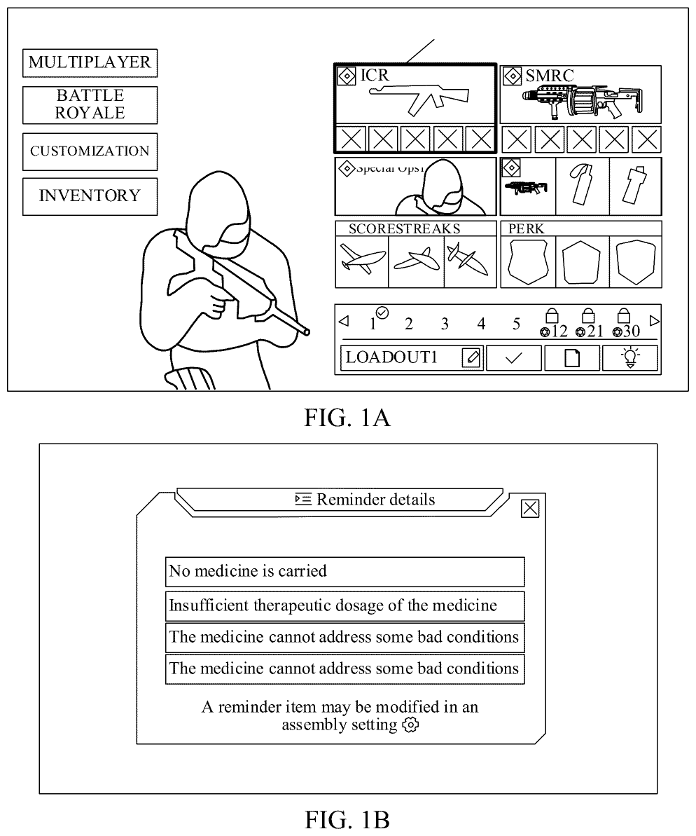

First, a data processing manner in a virtual scene according to the related art is described. FIG. 1A to FIG. 1C are schematic diagrams of data processing interfaces in a virtual scene in the related art. The following provides separate descriptions.

Refer to FIG. 1A. In an assembly interface, assembly information of a plurality of assembly items of a virtual object, for example, a shooting prop numbered 11 in FIG. 1A, is displayed. If a player needs to know whether the current shooting prop of the virtual object meets a preset configuration, the player needs to tap an icon numbered 11, to display related configuration information of the current shooting prop of the virtual object, for example, a type or a component. A user needs to manually verify and confirm, and perform manual detection on a next assembly item after the confirmation is completed, causing complex operations and high labor costs. In addition, because this manner completely relies on an independent check of the player, after the virtual scene runs (for example, a game is entered), many assembly items are not well set.

Refer to FIG. 1B. In a process of setting the assembly of the virtual object by the user, for each assembly dimension set by the user, after the user completes the setting and taps for determining, an assembly detection result interface for the assembly dimension is displayed, and in the assembly detection result interface, an assembly detection result for the assembly dimension set by the user is displayed. The detection occurs after the player performs a determining action, and is automatically performed but not actively triggered by the user. This strongly interrupts the assembly setting performed by the user, and causes the user to have unsmooth experience of setting the assembly.

Refer to FIG. 1C. During detection of the assembly, assembly dimensions are not distinguished, and detection results of assembly items of the virtual object are displayed in the interface together. Because the detection results are displayed after detection of all the assembly items of the virtual object is completed, the user waits for long time and lacks a sense of control over the assembly detection. In addition, because detection results of a plurality of assembly items are displayed in a same interface simultaneously, disordered interface information is caused.

Based on this, this disclosure provide a data processing method, apparatus, and system in a virtual scene, an electronic device, a computer-readable storage medium, and a computer program product, to implement one-tap detection on assembly of a virtual object, thereby improving detection efficiency of the assembly of the virtual object, and improving utilization of a hardware processing resource and a display resource of the device.

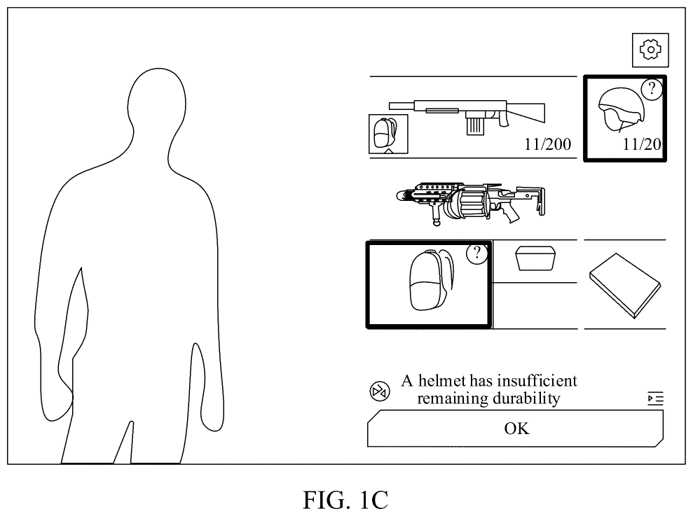

The data processing system in the virtual scene provided in this disclosure is described. FIG. 2 is a schematic diagram of an architecture of a data processing system 100 in a virtual scene according to an aspect of this disclosure. For example, a virtual scene client (for example, a game client) is disposed on a terminal 400. The terminal 400 is connected to a server 200 through a network 300. The network 300 may be a wide area network, a local area network, or a combination of the wide area network and the local area network, to implement data transmission through a wireless link or a wired link.

The terminal 400 is configured to: display, in an assembly detection interface of a virtual scene, a one-tap detection control corresponding to assembly of a virtual object, and transmit an assembly detection request for the virtual object to the server 200 when receiving a detection instruction triggered based on the one-tap detection control.

The assembly of the virtual object is configured for indicating assembly information of the virtual object in the virtual scene, the assembly includes at least two detection dimensions, and each detection dimension includes one or more detection items.

The server 200 is configured to: sequentially and automatically detect the assembly of the virtual object in the detection dimensions in response to the assembly detection request transmitted by the terminal, and return a corresponding detection result when assembly detection on each detection item is completed.

The terminal 400 is further configured to synchronously display a detection result of each detection item of the virtual object in each detection dimension along with execution of the detection.

In an aspect, the data processing method in the virtual scene provided in this disclosure may be implemented by various electronic devices, for example, may be implemented independently by a terminal, or may be implemented independently by a server, or may be implemented cooperatively by the terminal and the server. This disclosure may be applied to various scenarios, including but not limited to: a cloud technology, artificial intelligence, intelligent traffic, assisted driving, a game application, and the like.

In an aspect, the electronic devices that implement the data processing method in the virtual scene and that are provided in embodiments of this disclosure may be various types of terminal devices and servers. The server (for example, the server 200) may be an independent physical server, a server cluster or a distributed system including a plurality of physical servers, or a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. The terminal (for example, the terminal 400) may be but is not limited to: a smartphone, a tablet computer, a laptop computer, a desktop computer, a smart voice interactive device (for example, a smart speaker), a smart home appliance (for example, a smart television), a smartwatch, a vehicle-mounted terminal, or the like. The terminal and the server may be connected directly or indirectly in a wired communication manner or a wireless communication manner. This is not limited in embodiments of this disclosure.

In an aspect, the terminal or the server may implement the data processing method in the virtual scene provided in embodiments of this disclosure by running a computer program. For example, the computer program may be a native program or a software module in an operating system; or may be a native (Native) application (APP), to be specific, a program that needs to be installed in the operating system for running; or may be a mini program, to be specific, a program that can run provided that the program is downloaded into a browser environment; or may be a mini program that can be embedded into any APP. In conclusion, the computer program may be an application, a module or a plug-in in any form.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

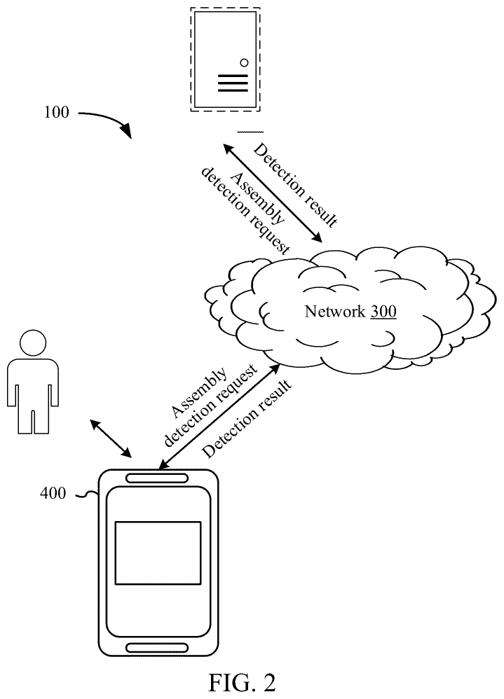

The following describes the electronic device that implements the data processing method in the virtual scene and that is provided in this disclosure. FIG. 3 is a schematic structural diagram of an electronic device 500 that implements a data processing method in a virtual scene and that is provided in this disclosure. An example in which the electronic device 500 is the terminal shown in FIG. 2 is used. The electronic device 500 provided in this disclosure includes: at least one processor 510, a memory 550, at least one network interface 520, and a user interface 530. Components in the electronic device 500 are coupled together by using a bus system 540. The bus system 540 is configured to implement connections and communication between these components. In addition to a data bus, the bus system 540 further includes a power bus, a control bus, and a status signal bus. However, for clear description, various buses are marked as the bus system 540 in FIG. 3.

Processing circuitry, such as the processor 510 may be an integrated circuit chip having a signal processing capability, for example, a general-purpose processor, a digital signal processor (DSP), another programmable logic device, a discrete gate or transistor logic device, or a discrete hardware component. The general-purpose processor may be a microprocessor, any conventional processor, or the like.

The memory 550 may be removable, non-removable, or a combination thereof. For example, hardware devices include a solid state memory, a hard disk drive, an optical disk drive, and the like. The memory 550 may include one or more storage devices physically away from the processor 510.

The memory 550, such as a non-transitory computer-readable storage medium, includes a volatile memory or a non-volatile memory, or may include both the volatile memory and the non-volatile memory. The non-volatile memory may be a read-only memory (ROM), and the volatile memory may be a random access memory (RAM). The memory 550 described in this disclosure aims to include any suitable type of memory.

In some embodiments, the memory 550 can store data to support various operations, and examples of the data include a program, a module, and a data structure, or include a subset or superset thereof.

An operating system 551 includes a system program configured to process various basic system services and execute a hardware-related task, for example, a framework layer, a core library layer, or a driver layer, and is configured to: implement various basic services and process a hardware-based task.

A network communication module 552 is configured to reach another computing device through one or more (wired or wireless) network interfaces 520. For example, the network interface 520 includes Bluetooth, wireless fidelity (Wi-Fi), and a universal serial bus (USB).

In an aspect, the data processing apparatus in the virtual scene provided in embodiments of this disclosure may be implemented in a software manner. FIG. 3 shows a data processing apparatus 553 in a virtual scene stored in the memory 550. The data processing apparatus may be software in a form of a program and a plug-in, and includes the following software modules: a first display module 5531, a detection module 5532, and a second display module 5533. These modules are logical and may be arbitrarily combined or split based on implemented functions. Functions of the modules are described below.

In another aspect, the data processing apparatus in the virtual scene provided in embodiments of this disclosure may be implemented in a manner of combining software and hardware. For example, the data processing apparatus in the virtual scene provided in embodiments of this disclosure may be a processor in a form of a hardware decoding processor that is programmed to perform the data processing method in the virtual scene provided in this disclosure. For example, the processor in the form of the hardware decoding processor may use one or more application-specific integrated circuits (ASICs), DSPs, programmable logic devices (PLDs), complex programmable logic devices (CPLDs), field programmable gate arrays (FPGAs), or other electronic elements.

Based on the foregoing descriptions of the data processing system in the virtual scene and the electronic device provided in this disclosure, the following describes the data processing method in the virtual scene provided in embodiments of this disclosure.

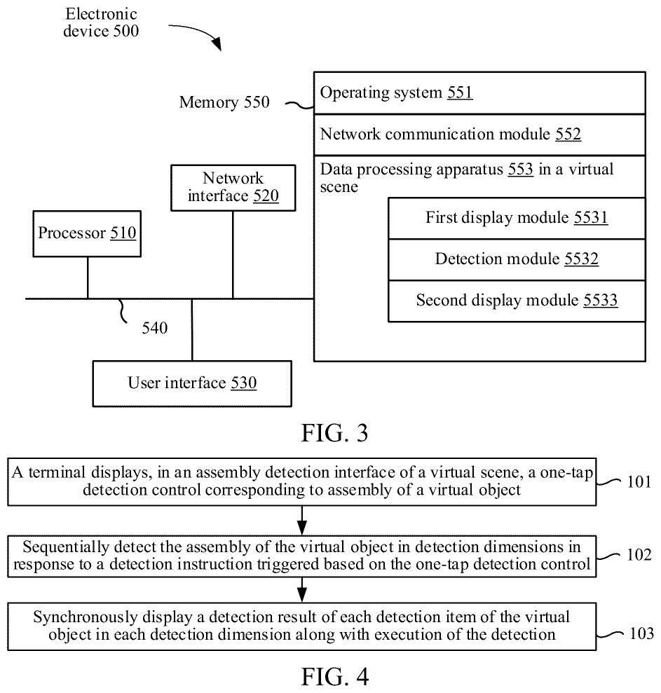

FIG. 4 is a schematic flowchart of a data processing method in a virtual scene according to an aspect of this disclosure. In some embodiments, the data processing method in the virtual scene may be implemented independently by a server or a terminal, or may be implemented cooperatively by the server and the terminal. An example in which the method is implemented by the terminal is used. The data processing method in the virtual scene provided in this aspect of this disclosure includes:

Operation 101: The terminal displays, in an assembly detection interface of a virtual scene, a one-tap detection control corresponding to assembly of a virtual object.

The assembly of the virtual object is configured for indicating assembly information of the virtual object in the virtual scene, and the assembly information includes equipment information and configuration information of the virtual object. The equipment information may include various virtual props, and the configuration information of the virtual object includes costume information, skill information, and the like of the virtual object. The assembly includes at least two detection dimensions, and each detection dimension includes one or more (at least two) detection items. For example, the detection dimensions may include an object dimension (for example, an arm dimension), a medicine dimension, and a container dimension, and each detection dimension includes one or more (in other words, at least two) detection items. For example, the object dimension may include the following detection items: a prop (for example, an attack prop) of the virtual object, a skill of the virtual object, and a costume of the virtual object.

Herein, for example, an application client is disposed in the terminal. The client may be a virtual scene client (for example, a game client), or may be a client having a virtual scene function, for example, an instant messaging client having a game function or a video playback client having a game function. An example in which the application client is a game client is used. When the terminal runs the game client, the game client displays an interface of the virtual scene, and a player may interact with a virtual object of another player in the virtual scene based on the interface of the virtual scene by using the virtual object corresponding to a login account of the player, for example, perform a virtual battle.

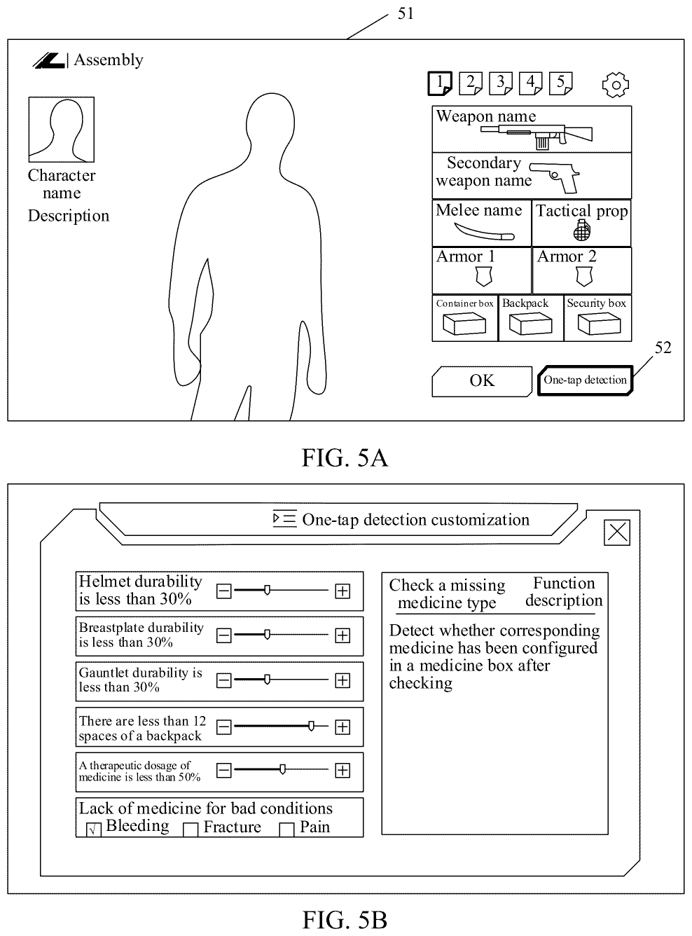

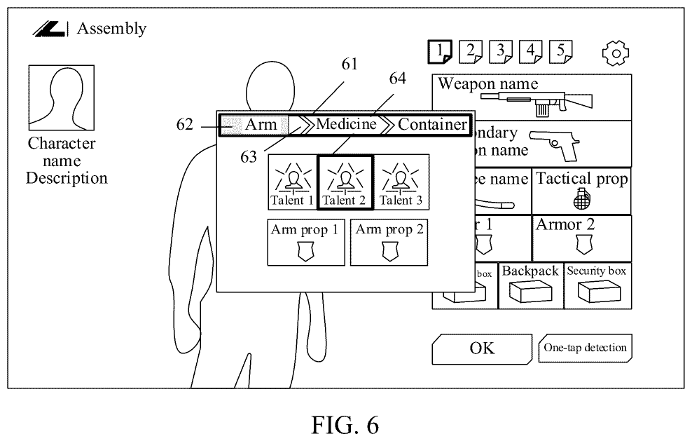

In an aspect, the terminal displays an assembly detection function item (namely, an assembly detection control or an assembly detection button) of the virtual object in the interface of the virtual scene. When receiving a triggering operation (for example, a single-tap operation or a double-tap operation) for the assembly detection function item, the terminal switches the displayed interface of the virtual scene to a displayed assembly detection interface of the virtual scene, and displays, in the assembly detection interface, a one-tap detection control (namely, a one-tap detection button) configured to perform one-tap detection on the assembly of the virtual object. FIG. 5A is a schematic diagram of an assembly detection interface according to an aspect of this disclosure. Refer to FIG. 5A. In the assembly detection interface 51, a one-tap detection control 52 configured to perform one-tap detection on assembly of a virtual object is displayed, so that a user triggers, based on the one-tap detection control 52, a detection instruction configured for instructing to detect the assembly of the virtual object.

For example, before detecting the assembly of the virtual object, a player may set a detection dimension in which detection is to be performed and assembly information of a detection item in each detection dimension. In some embodiments, the terminal displays a detection setting interface and displays a setting function item (namely, a setting control or a setting button) of the assembly information in the detection setting interface; and determines, in response to assembly information of at least two dimensions set based on the setting function item, the set dimensions as detection dimensions. In other words, for a plurality of assembly dimensions of the virtual object in a virtual scene, the player may set an assembly dimension in which detection is to be performed. In this way, autonomy of selecting, by the player, the assembly dimension in which detection is to be performed is achieved, thereby avoiding meaningless detection in an assembly dimension in which detection does not need to be performed and improving detection efficiency of the assembly. For example, the assembly dimensions of the virtual object include an arm dimension, a medicine dimension, a container dimension, and a replenishment dimension. The player may select the arm dimension, the medicine dimension, and the container dimension as the detection dimensions of the assembly detection.

Herein, for each detection dimension selected by the player, the player may select a detection item in the detection dimension. For a plurality of assembly items in each detection dimension, the player may select one or more assembly items as detection items. In other words, the player may select some assembly items in each detection dimension as the detection items. For example, the object dimension includes the following assembly items: a prop of the virtual object, a skill of the virtual object, and a costume of the virtual object. The player may select the prop of the virtual object and the skill of the virtual object as the detection items. Certainly, the player may alternatively not perform detection item selection. In this case, the plurality of assembly items in the detection dimension are all used as the detection items.

For example, the player needs to set assembly information corresponding to each detection item. For example, the detection dimension is a medicine dimension, a detection item in the medicine dimension is medicine, assembly information of the medicine includes a type of medicine that the virtual object needs to carry and a dosage of each type of the medicine, and the player may set the type of medicine that the virtual object needs to carry and the dosage of each type of medicine. For another example, the detection dimension is a prop dimension of the virtual object, and a detection item in the prop dimension includes a tactical prop and an armor. Assembly information of the tactical prop includes at least a type of a tactical prop that the virtual object needs to carry, and may further include a state of each type of the tactical prop. For example, the type of the tactical prop includes: a shooting prop and a throwing prop. The player may set the type of the tactical prop that the virtual object needs to carry, for example, set the virtual object to carry a particular shooting prop. Assembly information of the armor includes a type of the armor and a state of each type of the armor. For example, the type of the armor includes a helmet, a breastplate, and a gauntlet, and the state of each type of the armor is durability of the type of the armor. In this way, after the player sets the detection dimension and the assembly information of the detection item in each detection dimension, subsequently, when the assembly of the virtual object is detected, the detection may be performed based on the setting of the player. FIG. 5B is a schematic diagram of a setting interface for one-tap detection according to an aspect of this disclosure. Based on the setting interface for one-tap detection shown in FIG. 5B, a user may set assembly information of a detection item of a virtual object in each detection dimension. For example, for a detection item helmet shown in the setting interface, based on a current setting of the user, when assembly of the virtual object is detected, and when it is detected that durability of the current helmet of the virtual object in a virtual scene is less than 30%, the helmet is considered to be an abnormal detection item.

Operation 102: Sequentially detect the assembly of the virtual object in the detection dimensions in response to a detection instruction triggered based on the one-tap detection control.

Herein, the one-tap detection control is a control that performs one-tap triggering on the detection of the assembly of the virtual object in the detection dimensions. Through the one-tap detection control, one-tap detection on the assembly of the virtual object in the detection dimensions may be implemented and completed.

For example, the detection instruction may be triggered in a plurality of manners, for example, triggered by performing a single-tap operation, a double-tap operation, or a pressing operation on the one-tap detection control. A triggering manner of the one-tap detection control is not limited in this disclosure.

In an aspect, after receiving the detection instruction triggered based on the one-tap detection control, the terminal needs to sequentially detect the assembly of the virtual object in the detection dimensions. During actual implementation, the detection may be performed by the terminal, or the terminal sends an assembly detection request for the virtual object to the server, and the server sequentially detects the assembly of the virtual object in the detection dimensions, and returns a corresponding detection result when detection on assembly of each detection item is completed.

The detection result corresponding to each detection item is configured for indicating whether the corresponding detection item is abnormal.

Based on a detection dimension in which detection is to be performed and that is set in advance by the player, and the assembly information of the detection item in each detection dimension, in some embodiments, the assembly of the virtual object in the detection dimensions may be sequentially detected in the following manner: The terminal obtains assembly information of at least two dimensions (namely, assembly dimensions) set in advance, and current assembly information of the virtual object in the virtual scene; and for each detection item in each detection dimension, compares the assembly information set in advance with the current assembly information of the virtual object in the virtual scene, to obtain a comparison result, and uses the comparison result as a detection result for the detection item.

For example, the detection item is medicine. Assembly information of the medicine includes a type of medicine that the virtual object needs to carry and a dosage of each type of the medicine. The terminal obtains a type of medicine that the virtual object currently carries in the virtual scene and a dosage of each type of the medicine, and then compares the type of the medicine currently carried in the virtual scene with a preset type of medicine that the virtual object needs to carry, to obtain a first comparison result. When the first comparison result indicates that the two types are consistent, the dosage of the medicine currently carried by the virtual object is compared with a preset dosage of medicine, to obtain a second comparison result, the second comparison result is used as a detection result for the detection item, and the detection result is configured for indicating whether the detection item is abnormal. When the first comparison result indicates that the two types are inconsistent, the first comparison result is used as a detection result indicating that the detection item is abnormal.

In an aspect, the detection instruction is triggered by a pressing operation for the one-tap detection control. When the user performs the pressing operation for the one-tap detection control, the terminal determines whether the pressing operation meets an instruction triggering condition. The instruction triggering condition may be at least one of the following: press duration reaches a duration threshold, and a pressure value reaches a pressure threshold. When the terminal determines that the pressing operation for the one-tap detection control meets the instruction triggering condition, the detection instruction is triggered. Correspondingly, the terminal may sequentially detect the assembly of the virtual object in the detection dimensions in the following manner: The terminal sequentially detects the assembly of the virtual object in the detection dimensions in a process of performing the pressing operation; and stops (for example, pause), before the detection ends and when the pressing operation is released, performing the detection. In this way, provided that the pressing operation of the user for the one-tap detection control is continuously performed, the assembly of the virtual object in the detection dimensions can be automatically and sequentially detected, thereby improving detection efficiency of the assembly in the detection dimensions.

In an aspect, the detection instruction may be further triggered by a dragging operation for the one-tap detection control. When the user performs the dragging operation for the one-tap detection control, the terminal determines whether the dragging operation meets an instruction triggering condition. The instruction triggering condition may be that a dragging distance reaches a distance threshold. When the terminal determines that the pressing operation for the one-tap detection control meets the instruction triggering condition, the detection instruction is triggered. Correspondingly, the terminal may sequentially detect the assembly of the virtual object in the detection dimensions in the following manner: The terminal sequentially detects the assembly of the virtual object in the detection dimensions in a process of performing the dragging operation; and stops, before the detection ends and when the dragging operation is released, performing the detection. In this way, provided that the dragging operation of the user for the one-tap detection control is continuously performed, the assembly of the virtual object in the detection dimensions can be automatically and sequentially detected, thereby improving detection efficiency of the assembly in the detection dimensions.

For example, to help the user clearly understand how to trigger the detection instruction based on the one-tap detection control and complete detection of a plurality of detection items in each detection dimension, after displaying, in the assembly detection interface, the one-tap detection control corresponding to the assembly of the virtual object, the terminal may display detection guidance information. The detection guidance information is configured for prompting to perform the pressing operation or the dragging operation, to implement automatic detection on the assembly of the virtual object in at least two detection dimensions. For example, the detection guidance information may be a detection guidance animation configured for guiding execution of the pressing operation or the dragging operation. The detection guidance information may alternatively be graphic guidance information configured for guiding the player to perform the pressing operation or the dragging operation, to implement automatic detection on the assembly of the virtual object in at least two detection dimensions. During actual implementation, the detection guidance information may be displayed only when the user uses a one-tap detection function for the first time, and may not need to be displayed subsequently, to reduce a waste of display resources caused by repeated display.

Operation 103: Synchronously display a detection result of each detection item of the virtual object in each detection dimension along with execution of the detection.

Herein, the term “synchronization” is described. In some embodiments, the term “synchronization” is configured for indicating that in a process of performing the detection, the terminal displays the detection result of each detection item of the virtual object in each detection dimension. In some other embodiments, the term “synchronization” is configured for indicating that the detection result of each detection item in each detection dimension is displayed synchronously, in other words, detection results of detection items in the detection dimensions are displayed together.

In an aspect, in a process of detecting the assembly of the virtual object, progress indication information is displayed. The progress indication information is configured for indicating progress of detecting the assembly of the virtual object in each detection dimension. In this way, the player can clearly learn of the progress of the current assembly detection and has a sense of control over the detection of the assembly, thereby improving user experience.

For example, the progress indication information may be displayed in a form of a pop-up window, and the progress indication information may be displayed in a plurality of manners. For example, the detection progress of the assembly in each detection dimension is indicated by using at least one of a text mode, a voice broadcast mode, or a graphic mode. For the text mode, for example, that “detection is currently performed in the second detection dimension, there is one detection dimension left, and 60% of the detection has been completed in the current detection dimension” is displayed. For the voice broadcast mode, for example, that “detection is currently performed in the second detection dimension, there is one detection dimension left, and 60% of the detection has been completed in the current detection dimension” is broadcast by using a voice. For the graphic mode, for example, the detection progress of the assembly in each detection dimension is displayed by using a progress bar.

Displaying the detection progress of the assembly in each detection dimension by using the progress bar is described. In some embodiments, a progress indicator bar is displayed, and the progress indicator bar includes detection dimension identifiers of detection dimensions that are sequentially arranged (where the identifier may be at least one of a name and an icon). In the process of detecting the assembly of the virtual object, in the progress indicator bar, a detection dimension identifier of a detection dimension in which the assembly detection has been completed is displayed by using a first style; a first part of a detection dimension identifier of a current detection dimension is displayed by using a second style; and a detection dimension identifier of a detection dimension in which the assembly detection has not been completed and a second part of the detection dimension identifier of the current detection dimension are displayed by using a third style. In this way, a display resource of an electronic device is fully utilized, and the detection progress of the detection dimensions is displayed differently in the progress indicator bar. This allows the player to have an intuitive overall understanding of the detection progress of the detection dimensions.

The first part corresponds to a detection item on which the assembly detection has been completed in the current detection dimension, and the second part corresponds to a detection item on which the assembly detection has not been completed in the current detection dimension. The first style and the second style may be the same or different. The first style is different from the third style, and the second style is different from the third style.

In an aspect, a currently detected detection item in the current detection dimension may further be displayed in the progress bar, so that the process of the assembly detection is more finely presented.

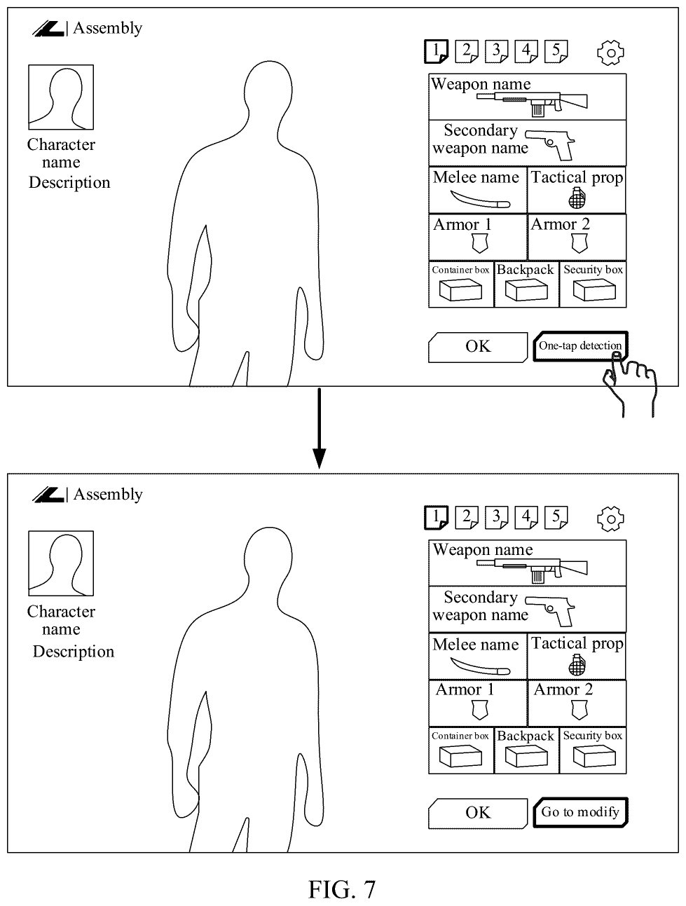

For example, FIG. 6 is a schematic diagram of a progress indication of assembly detection according to an aspect of this disclosure. Refer to FIG. 6. In a progress indicator bar 61, detection dimension names of detection dimensions that are sequentially arranged are displayed: “arm”, “medicine”, and “container”. For display of the “arm” in the progress indicator bar, a display style of a first part 62 is a second style, where the second style is configured for indicating a part on which the assembly detection has been completed in the “arm” dimension. A display style of a second part 63 is a third style, where the third style is configured for indicating a part on which the assembly detection has not been completed in the “arm” dimension. A display style of the detection dimension (“medicine” and “container”) in which the assembly detection has been completed in the progress indicator bar is the same as the second part 63 of the “arm” dimension. It can be learned from the progress bar that the detection dimension in which the detection is currently performed is the arm dimension, and a detection item being detected in the current detection dimension is numbered by 64, that is, a talent 2. In this way, a user can clearly learn of detection of a virtual object in each detection dimension, and have a sense of control over a detection process and detection time, thereby improving user experience.

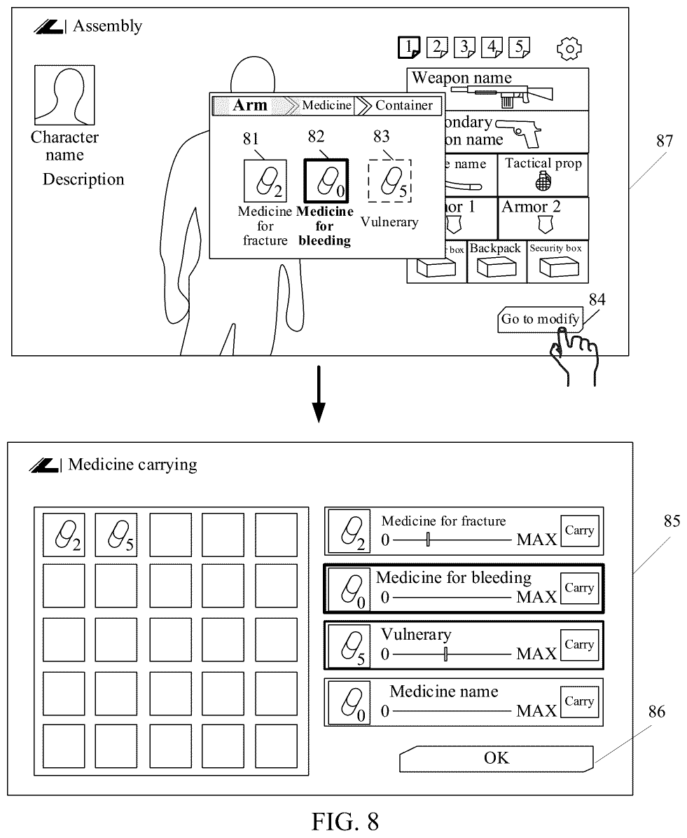

In an aspect, when an operation triggering a detection instruction is a tap operation (for example, a single-tap operation or a double-tap operation) for a one-tap detection control, a terminal switches, after receiving the detection instruction, display of the one-tap detection control to display of an assembly modification control. The assembly modification control is configured to modify assembly of the virtual object. In this way, after a function of the one-tap detection control is triggered, the one-tap detection control is replaced with the assembly modification control. This provides the user with a function of modifying the assembly of the virtual object without additionally occupying a display resource of an electronic device, and improves utilization of the display resource. FIG. 7 is a schematic diagram in which a one-tap detection control is switched to an assembly modification control according to an aspect of this disclosure. Refer to FIG. 7. When a user taps a “one-tap detection” button, the “one-tap detection” button switches to a “go to modify” button (namely, the assembly modification control).

In some aspects, a terminal may synchronously display a detection result of each detection item of a virtual object in each detection dimension in the following manner: For a current detection dimension, the terminal displays, in an assembly detection interface, a detection dimension identifier of the current detection dimension and a detection item identifier of each detection item in the current detection dimension. When there is an abnormal detection item in detection items, a detection item identifier of the abnormal detection item is displayed by using a fourth style, and a detection item identifier of a normal detection item in the detection items is displayed by using a fifth style. The fourth style is different from the fifth style. In this way, the normal detection item and the abnormal detection item in the detection result are distinguished based on the styles, so that the user can clearly learn of the detection item that is abnormal in the current detection dimension.

For example, along with execution of the detection, when the synchronously displayed detection result shows that there is an abnormal detection item in assembly of the virtual object in a first detection dimension, the user may modify, based on the assembly modification control displayed in the interface, assembly information corresponding to the abnormal detection item. For example, the terminal displays, in response to a triggering operation (for example, a single-tap operation or a double-tap operation) for the assembly modification control, a setting interface corresponding to the abnormal detection item. The setting interface is configured for setting the assembly information corresponding to the abnormal detection item. In this way, the user may modify, based on the setting interface corresponding to the abnormal detection item, the assembly information corresponding to the abnormal detection item to normal.

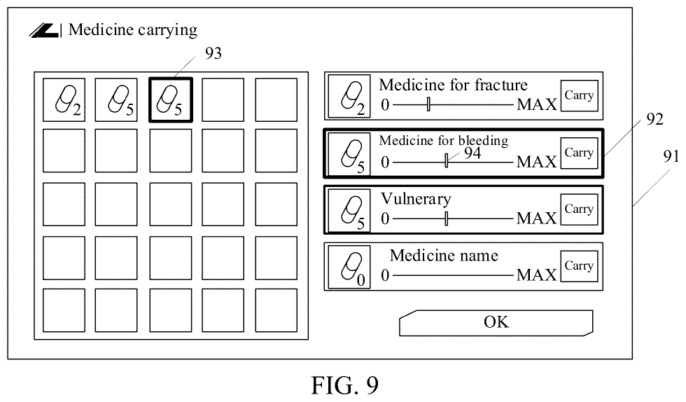

For example, FIG. 8 is a schematic diagram of displaying a detection result of assembly according to an aspect of this disclosure. Refer to FIG. 8. When a terminal detects a detection dimension of medicine, a detection result for the detection dimension is displayed. As shown in FIG. 8, a number 81 is a detection item that has been detected and has a normal detection result, and a number 82 is a detection item that has been detected and has an abnormal detection result. It can be learned from FIG. 8 that a state of medicine for bleeding (a dosage of the medicine for bleeding) is abnormal, that is, the medicine for bleeding is an abnormal detection item. A number 83 is a detection item that has not been detected. Display styles of the detection items indicated by the number 81, the number 82, and the number 83 are different from each other. In an assembly detection interface, an assembly modification control, namely, a “go to modify” button 84 is further displayed. When a user taps the “go to modify” button 84, the interface jumps to a setting interface 85 corresponding to the medicine for bleeding. In the setting interface 85, the user may set the dosage of the medicine for bleeding.

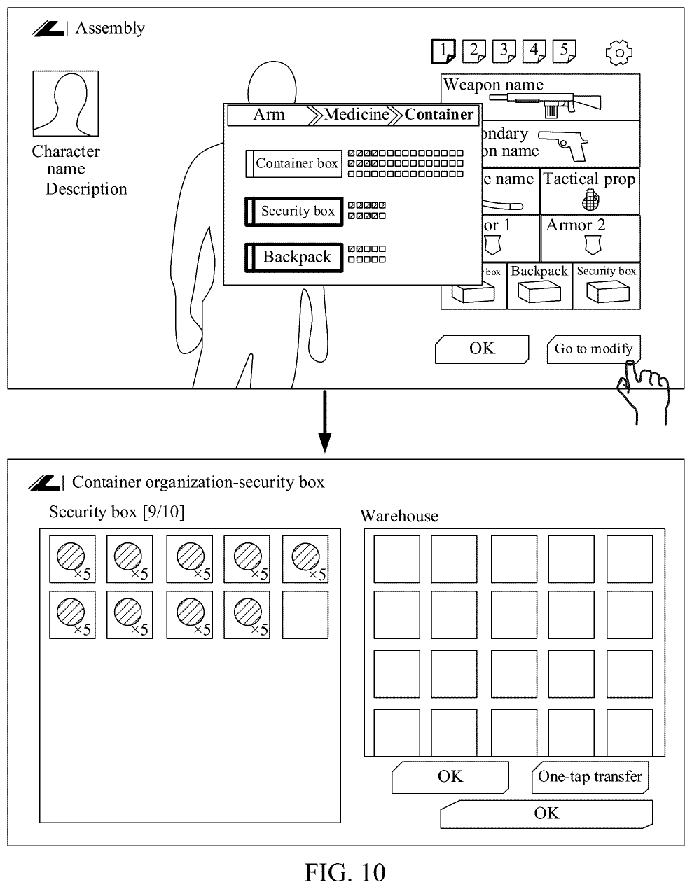

Herein, for example, the terminal may automatically perform an auxiliary setting on assembly information of the abnormal detection item. In an aspect, the terminal displays, in the setting interface, a setting result obtained by performing the auxiliary setting on the assembly information corresponding to the abnormal detection item, and a setting control corresponding to the abnormal detection item. The setting control is configured to adjust the setting result. FIG. 9 is a schematic diagram of an interface of an assembly auxiliary setting according to an aspect of this disclosure. Refer to FIG. 9. When a user triggers an assembly modification control in an assembly detection interface, for example, taps the “go to modify” button shown in FIG. 8, a setting interface 91 is displayed. In the setting interface 91, a dosage 92 and a dosage 93 of the medicine for bleeding that are automatically set for the user are displayed, in other words, the dosage of the medicine for bleeding is automatically adjusted from 0 to 5. The automatically set dosage may be a dosage set by the user when setting assembly information of each detection item. When the user is not satisfied with dosage of medicine obtained through an auxiliary setting of a terminal, a setting result obtained by performing the auxiliary setting may be adjusted based on a setting control 94. In this way, an auxiliary setting of assembly information of an abnormal detection item is implemented, and setting efficiency of the assembly information of the abnormal detection item is improved.

In an aspect, when triggering time corresponding to a triggering operation for the assembly modification control is before the end of detection of assembly of a virtual object, the terminal cancels, in response to a set completion instruction triggered based on the setting interface, display of the setting interface, returns to the assembly detection interface, and continues to detect the assembly of the virtual object. In this way, in a process of assembly detection, the assembly information corresponding to the abnormal detection item is modified in time. A case in which when there are a plurality of abnormal detection items after detection in a plurality of detection dimensions is completed, an abnormal detection item may be missed due to one-by-one modification of the user is avoided.

The example shown in FIG. 8 is still used herein. When the user completes setting the dosage of the medicine for bleeding, after a determining button 86 is taped, the set completion instruction is triggered, and the terminal cancels the display of the setting interface 85, returns to the assembly detection interface 87, and continues to detect the assembly of the virtual object

In an aspect, if a current detection dimension is a first detection dimension, and when triggering time corresponding to a triggering operation for the assembly modification control is before the end of detection of assembly of a virtual object, the terminal displays, in response to a set completion instruction triggered based on the setting interface, a dimension detection interface corresponding to a second detection dimension, where the dimension detection interface displays a determining control; and the terminal displays, when receiving a triggering operation for the determining control, an assembly detection interface that corresponds to a third detection dimension and that includes the determining control. In other words, once the user triggers the triggering operation for the assembly modification control in the assembly detection interface, the terminal no longer returns the automatic detection for each detection dimension. Instead, after detection is performed in each detection dimension and a detection result is displayed, detection on each detection item in a next detection dimension is only performed when the user needs to perform the triggering operation for the determining control.

For example, there are a plurality of abnormal detection items in one detection dimension. In an aspect, when there are at least two abnormal detection items, and the at least two abnormal detection items have corresponding rankings in the detection result, the terminal may display, in response to the triggering operation for the assembly modification control, setting interfaces corresponding to the abnormal detection items in the following manner: The terminal sequentially displays, based on the rankings of the abnormal detection items in the detection result, the setting interfaces corresponding to the abnormal detection items.

Herein, when there are at least two abnormal detection items, the rankings of the at least two abnormal detection items in the detection result may correspond to degrees of impact of the abnormal detection items on interaction of the virtual object in a virtual scene. For example, there are there abnormal detection items: an abnormal detection item A, an abnormal detection item B, and an abnormal detection item C. When degrees of impact of the three abnormal detection items on interaction of the virtual object in the virtual scene are ranked in descending order as follows: the abnormal detection item A, the abnormal detection item C, and the abnormal detection item B, correspondingly, rankings of the three abnormal detection items in the detection result are also the abnormal detection item A, the abnormal detection item C, and the abnormal detection item B.

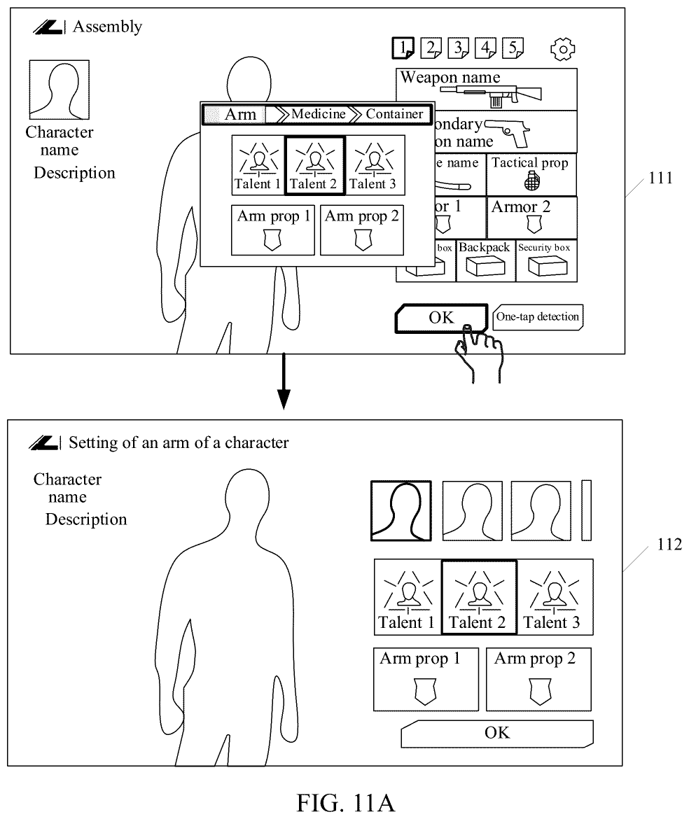

For example, FIG. 10 is a schematic diagram of display interfaces of a plurality of abnormal detection items according to an aspect of this disclosure. Refer to FIG. 10. In a process of detecting a container dimension of a virtual object, there are two abnormal detection items: a security box and a backpack. When a user performs a triggering operation for an assembly modification control displayed in the interface, because detection items are sequentially arranged from top to bottom in an assembly detection interface in the container dimension, a terminal first displays, based on the top-bottom order, a setting interface corresponding to the abnormal detection item, namely, the security box. The user may set an item in the security box based on the setting interface corresponding to the security box. For example, the item is transferred from a warehouse to the security box by using a transfer control and a one-tap transfer control in the setting interface. After the user completes the setting and when the user taps a determining control, the terminal cancels display of the setting interface corresponding to the security box, and displays a setting interface corresponding to the backpack, so that the user sets, based on the setting interface corresponding to the backpack, an item in the backpack.

When a detection instruction is triggered by a pressing operation for a one-tap detection control, in an aspect, before the detection ends, and after the pressing operation is released and the detection is stopped, if a detection result indicates that there is an abnormal detection item in assembly of the virtual object, the terminal automatically jumps to the setting interface corresponding to the abnormal detection item for the user to set. In this way, the user does not need to actively perform the triggering operation for the assembly modification control, to reduce human-computer interaction operations and improve detection efficiency of the assembly and setting efficiency for assembly information of the abnormal detection item.

In an aspect, the terminal displays the determining control in the assembly detection interface. In a process of performing the detection, when receiving a triggering operation for the determining control, the terminal ends detection for at least two detection dimensions, and jumps to a dimension detection interface corresponding to a current detection dimension. In a process of performing the detection, when a triggering operation for the determining control is not received and detection for at least two detection dimensions is completed, the terminal cancels display of the determining control, and displays confirmed prompt information that is configured for indicating that the detection result has been confirmed. In this way, when the assembly detection is completed, the display of the determining control is canceled, a display resource of a device is released, and the confirmed prompt information is displayed, thereby improving utilization of the display resource.

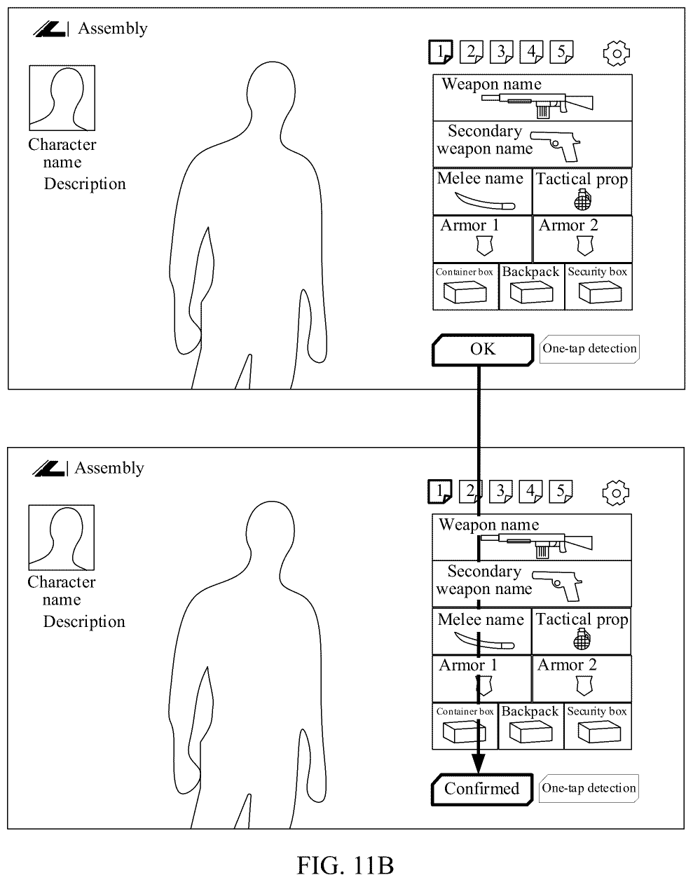

For example, FIG. 11A and FIG. 11B each are a schematic diagram of a determining control in a detection interface according to an aspect of this disclosure. Refer to FIG. 11A. In an assembly detection interface 111, a determining control is displayed. In a process of detecting assembly based on the assembly detection interface, when a user taps the determining control, a terminal ends a one-tap detection procedure of the assembly, and jumps to a dimension detection interface 112 corresponding to a current detection dimension, namely, an arm dimension.

Refer to FIG. 11B. In an assembly detection interface, a determining control (namely, an “OK” button in FIG. 11B) and a one-tap detection control (namely, a “one-tap detection” button in FIG. 11B) are displayed, a user triggers a detection instruction based on the one-tap detection control, and a terminal performs assembly detection for a virtual object. When a triggering operation for the “OK” button is not received in a process of performing the detection, and detection for at least two detection dimensions is completed, display of the “OK” button is canceled and confirmed prompt information that is configured for indicating a confirmed detection result is displayed, that is, “confirmed” is displayed at the original “OK” button.

The foregoing aspects of this disclosure are used. When the user triggers the detection instruction based on the one-tap detection control, one-tap detection on a plurality of detection items of the virtual object in a plurality of detection dimensions may be implemented. Compared with a complex detection procedure in the related art, in aspects of this disclosure, detection efficiency of the assembly of the virtual object in the virtual scene is improved, and utilization of a hardware processing resource and a display resource of the device is improved. Because the detection of the assembly is sequentially performed dimension by dimension, and the detection result of each detection item of the virtual object in each detection dimension can be synchronously displayed in the process of assembly detection, the user can clearly learn of each detection item in the detection process. Because the display of the detection result of each detection item is not performed after the detection of all detection items is completed, but is displayed synchronously along with the execution of the detection, the user can feel the progress of the assembly detection, thereby improving a sense of control of the user over the assembly detection.

The following describes an example of this disclosure. A data processing method in a virtual scene provided in this disclosure is described by using an example in which the virtual scene is a game. In the data processing method in the virtual scene provided in this disclosure, assembly of a virtual object can be automatically detected without a plurality of operations of a player, and according to a detection standard set by the player, the player is quickly helped to detect whether there is a configuration that needs to be set. The configuration herein is assembly information of the virtual object in the virtual scene, for example, a customized setting for equipment, a slot, or a skill of the virtual object.

The assembly detection in an aspect of this disclosure may include a strong procedure of basic confirmation and a one-tap detection procedure. In the strong procedure of basic confirmation, the player is guided, in an automatic jumping manner, to perform assembly, a terminal performs assembly detection dimension by dimension in at least two assembly dimensions, and each jump, to be specific, triggering of detection in a next detection dimension, needs to be triggered by the player by performing a tap operation for a determining button based on the determining button displayed in a detection interface of a current detection dimension. In other words, after detection of each detection dimension is completed, the player needs to perform confirmation before performing detection in a next assembly dimension. In the one-tap detection procedure, the terminal sequentially performs automatic detection on a plurality of detection items in each assembly dimension without intervention of the player, and synchronously outputs a detection result of each detection item in a detection process.

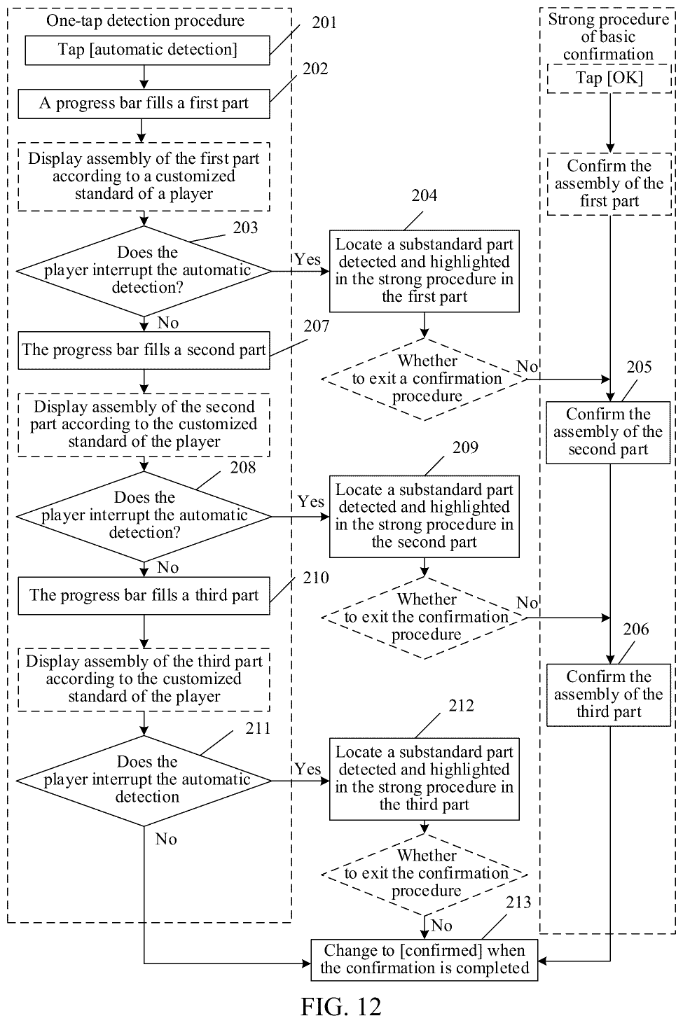

FIG. 12 is a schematic flowchart of a data processing method in a virtual scene according to an aspect of this disclosure. Refer to FIG. 12. the data processing method in the virtual scene provided in this aspect of this disclosure is described by using an example in which there are three detection dimensions of assembly: a detection dimension a, a detection dimension b, and a detection dimension c.

Operation 201: A player taps a one-tap detection button.

Herein, a terminal displays an assembly detection interface, and the player starts to perform assembly. When the player does not want to perform a strong procedure by performing a confirmation operation step by step, the one-tap detection button is taped to trigger a one-tap detection instruction.

Operation 202: A progress bar gradually fills a first part.

Herein, the terminal sequentially performs automatic detection on the assembly in the three detection dimensions in response to the one-tap detection instruction. In other words, the terminal starts to determine, according to a set customized detection standard (namely, assembly information of each detection item in the detection dimensions set by the player, where a default detection standard is not customized), whether the detection dimension a meets the detection standard set by the player. If a part that does not meet the standard (to be specific, a detection item that does not meet the standard) is detected, the player is prompted with a corresponding warning state, to inform the player that the detection item is abnormal, for example, by using a graphical prompt to highlight or dynamically flash an icon corresponding to the detection item. Otherwise, the display is normal.

In a process of the automatic detection, progress of the detection is displayed by using the progress bar. Identifiers (for example, names) of the detection dimension a, the detection dimension b, and the detection dimension c are sequentially displayed in the progress bar. For the display of the progress bar, refer to FIG. 6, and the first part herein is a part corresponding to the detection dimension a in the progress bar. In addition, in the process of the automatic detection, the terminal displays assembly of the first part according to the customized standard of the player, to be specific, displays a detection result of each detection item in the detection dimension a, where the detection result is configured for indicating whether the detection item is normal. In an aspect, filling of the progress bar requires is to 1.5 s.

Operation 203: The terminal determines whether the player interrupts the automatic detection, and if the player interrupts the automatic detection, performs operation 204; otherwise, performs operation 207.

Herein, the terminal determines, in real time in the process of the automatic detection, whether the player interrupts the automatic detection. For example, when the player taps a “go to modify” button in the assembly detection interface, the interruption of the automatic detection is triggered, and the terminal enters a strong procedure of basic confirmation.

Operation 204: Locate a substandard part detected and highlighted in the strong procedure in the first part.

Herein, when a detection result of a one-tap detection procedure indicates that there is an abnormal detection item, to be specific, there is an assembly item that does not meet the standard set by the player, the terminal may highlight and display the abnormal detection item in the detection result, to prompt the player. In this case, if the player taps the “go to modify” button in the assembly detection interface, the terminal jumps to a setting interface (for example, the setting interface 85 shown in FIG. 8) corresponding to the abnormal detection item, so that the player sets assembly information of the abnormal detection item, and detects, in real time, whether the terminal exits the strong procedure of basic confirmation. Exiting the strong procedure of the basic confirmation herein is processing of exiting the assembly detection. For example, the player performs a shutdown operation for the game client. In the setting interface corresponding to the abnormal detection item, the terminal may display a result of automatically performing an auxiliary setting on the assembly information of the abnormal detection item. This improves convenience of interaction. Even if the assembly needs to be changed, it can be completed quickly and conveniently.

For example, when the player completes the setting of the assembly information of the abnormal detection item and taps the determining button displayed in the setting interface, the terminal is triggered to perform operation 205.

Operation 205: Confirm assembly of a second part.

The assembly of the second part herein is assembly corresponding to the detection dimension b. When the player taps the determining button displayed in the setting interface corresponding to the abnormal detection item, the terminal performs detection in the detection dimension b and displays a detection result of each detection item in the detection dimension b for the player to confirm. After the player performs confirmation, the terminal is triggered to perform operation 206

Operation 206: Confirm assembly of a third part.

Herein, after the player detects the assembly corresponding to the detection dimension b, the terminal performs detection in the detection dimension c, and displays a detection result of each detection item in the detection dimension c for the player to confirm. After the player performs confirmation, the terminal is triggered to perform operation 207.

Operation 207: The progress bar gradually fills the second part.

Herein, when the progress bar displayed by the terminal starts to fill the second part, it indicates that the automatic detection for the detection dimension a is completed, in other words, the first part of the progress bar is filled, and the second part is a part corresponding to the detection dimension b in the progress bar. The detection performed in the detection dimension b by the terminal is similar to the detection performed in the detection dimension a by the terminal. It is determined whether the detection dimension b meets the detection standard set by the player. If a part that does not meet the standard (to be specific, a detection item that does not meet the standard) is detected, the player is prompted with a corresponding warning state, to inform the player that the detection item is abnormal. The terminal displays the assembly of the second part according to the customized standard of the player, to be specific, displays the detection result of each detection item in the detection dimension b, where the detection result is configured for indicating whether the detection item is normal.

Operation 208: The terminal determines whether the player interrupts the automatic detection, and if the player interrupts the automatic detection, performs operation 209; otherwise, performs operation 210.

Operation 209: Locate a substandard part detected and highlighted in the strong procedure in the second part.

Herein, when the detection result of the detection dimension b indicates that there is an abnormal detection item (namely, the assembly item that does not meet the standard), when the player taps the “go to modify” button, the terminal jumps to a setting interface corresponding to the abnormal detection item, so that after the setting of the player is completed, the terminal is triggered to perform operation 206.

Operation 210: The progress bar fills a third part.

Herein, when the progress bar displayed by the terminal starts to fill the third part, it indicates that the automatic detection for the detection dimension b is completed, in other words, the second part of the progress bar is filled, and the third part is a part corresponding to the detection dimension c in the progress bar. The detection performed in the detection dimension c by the terminal is similar to the detection performed in the detection dimension a and the detection dimension c by the terminal. It is determined whether the detection dimension c meets the detection standard set by the player. If a part that does not meet the standard (to be specific, a detection item that does not meet the standard) is detected, the player is prompted with a corresponding warning state, to inform the player that the detection item is abnormal. The terminal displays the assembly of the second part according to the customized standard of the player, to be specific, displays the detection result of each detection item in the detection dimension c.

Operation 211: The terminal determines whether the player interrupts the automatic detection, and if the player interrupts the automatic detection, performs operation 212; otherwise, performs operation 213.

Herein, a process in which the terminal determines whether the player interrupts the automatic detection is the same as the foregoing process, and details are not described herein again.

Operation 212: Locate a substandard part detected and highlighted in the strong procedure in the third part.

Processing of the terminal herein is similar to operation 204 and operation 209, and details are not described herein again.

Operation 213: The terminal completes the confirmation.

Herein, when the terminal completes the detection for the assembly, confirmed prompt information is displayed, for example, “OK” displayed in a determining control is switched to “confirmed”.

According to the foregoing aspect of this disclosure, the player can implement one-tap detection on a plurality of detection items of the virtual object in a plurality of detection dimensions, to reduce time costs of the assembly detection without a need of a mandatory procedure, and reduce a sense of burden of player experience and a sense of interruption of a rapid next round. Two paths are provided: the one-tap detection procedure and the strong procedure of basic confirmation, so that the player can select a most comfortable experience path. In addition, the player may customize a detection standard corresponding to the detection item in each detection dimension, so that the detection better meets an actual requirement of the user. In the setting interface corresponding to the abnormal detection item, the terminal may display a result of automatically performing an auxiliary setting on the assembly information of the abnormal detection item. In this way, convenience of interaction is improved. For each detection dimension, the detection result in the detection dimension is displayed in a centralized manner, to be specific, information that needs to be confirmed by the player is displayed in a concentrated manner to ensure that the player does not perform an incorrect configuration.

A data processing apparatus 553 in a virtual scene provided in an aspect of this disclosure is described. The data processing apparatus 553 in the virtual scene provided in this aspect of this disclosure includes:
a first display module 5531, configured to display, in an assembly detection interface of a virtual scene, a one-tap detection control corresponding to assembly of a virtual object,
the assembly of the virtual object being configured for indicating assembly information of the virtual object in the virtual scene, the assembly including at least two detection dimensions, and each detection dimension including at least two detection items;
a detection module 5532, configured to sequentially detect the assembly of the virtual object in the detection dimensions in response to a detection instruction triggered based on the one-tap detection control; and
a second display module 5533, configured to synchronously display a detection result of each detection item of the virtual object in each detection dimension along with execution of the detection.

In an aspect, the second display module is further configured to display progress indication information in a process of detecting the assembly of the virtual object, where the progress indication information is configured for indicating progress of the detection of the assembly of the virtual object in each detection dimension.

In an aspect, the second display module is further configured to: display a progress indicator bar, where the progress indicator bar includes detection dimension identifiers of the detection dimensions that are sequentially arranged; and
in the process of detecting the assembly of the virtual object, in the progress indicator bar, display, by using a first style, a detection dimension identifier of a detection dimension in which the assembly detection has been completed; display a first part of a detection dimension identifier of a current detection dimension by using a second style; and display, by using a third style, a detection dimension identifier of a detection dimension in which the assembly detection has not been completed and a second part of the detection dimension identifier of the current detection dimension, where
the first part corresponds to a detection item on which the assembly detection has been completed in the current detection dimension, and the second part corresponds to a detection item on which the assembly detection has not been completed in the current detection dimension.

In an aspect, the first display module is further configured to: receive the detection instruction in response to a tap operation for the one-tap detection control; and
switch display of the one-tap detection control to display of an assembly modification control, where
the assembly modification control is configured to modify the assembly of the virtual object.

In an aspect, the second display module is further configured to: when the detection result indicates that there is an abnormal detection item in the assembly of the virtual object in a first detection dimension,
display, in response to a triggering operation for the assembly modification control, a setting interface corresponding to the abnormal detection item, where
the setting interface is configured for setting assembly information corresponding to the abnormal detection item.

In an aspect, the second display module is further configured to: when triggering time corresponding to the triggering operation is before the end of the detection of the assembly of the virtual object, cancel, in response to a set completion instruction triggered based on the setting interface, display of the setting interface, return to the assembly detection interface, and continue to detect the assembly of the virtual object.

In an aspect, the detection for the at least two detection dimensions is performed sequentially.

The second display module is further configured to: when triggering time corresponding to the triggering operation is before the end of the detection of the assembly of the virtual object, display, in response to a set completion instruction triggered based on the setting interface, a dimension detection interface corresponding to a second detection dimension, where the dimension detection interface displays a determining control; and
display, when a triggering operation for the determining control is received, an assembly detection interface that corresponds to a third detection dimension and that includes the determining control.

In an aspect, the second display module is further configured to display, in the setting interface, a setting result obtained by performing an auxiliary setting on the assembly information corresponding to the abnormal detection item, and a setting control corresponding to the abnormal detection item, where
the setting control is configured to adjust the setting result.

In an aspect, the second display module is further configured to: when there are at least two abnormal detection items, and the at least two abnormal detection items have corresponding rankings in the detection result,
sequentially display, based on the rankings of the abnormal detection items in the detection result, setting interfaces corresponding to the abnormal detection items.

In an aspect, the first display module is further configured to: when a pressing operation meets an instruction triggering condition, receive the detection instruction in response to the pressing operation for the one-tap detection control.

The detection module is further configured to: sequentially detect the assembly of the virtual object in the detection dimensions in a process of performing the pressing operation; and

Stop (for example, pause), before the detection ends and when the pressing operation is released, performing the detection.

In an aspect, the first display module is further configured to display a detection guidance animation, where the detection guidance animation is configured for guiding execution of the pressing operation, to implement automatic detection on the assembly of the virtual object in the at least two detection dimensions.

In an aspect, the second display module is further configured to synchronously display the detection result of each detection item in the process of performing the pressing operation; and
when the detection result indicates that there is an abnormal detection item in the assembly of the virtual object, automatically jump to a setting interface corresponding to the abnormal detection item.

In an aspect, the detection for the at least two detection dimensions is performed sequentially.

The first display module is further configured to: display the determining control in the assembly detection interface; and
in a process of performing the detection, when the triggering operation for the determining control is received, end automatic detection for the at least two detection dimensions, and jump to a dimension detection interface corresponding to the current detection dimension; or
in a process of performing the detection, when the triggering operation for the determining control is not received and automatic detection for the at least two detection dimensions is completed, cancel (for example, close) display of the determining control, and display confirmed prompt information that is configured for indicating that the detection result has been confirmed.

In an aspect, the first display module is further configured to: display a detection setting interface, and display a setting function item (for example, setting option) of the assembly information in the detection setting interface; and
determine, in response to assembly information of at least two dimensions set based on the setting function item, the set dimensions as the detection dimensions.

In an aspect, the detection module is further configured to: obtain the assembly information of the at least two dimensions set in advance, and the current assembly information of the virtual object in the virtual scene; and
for each detection item in each detection dimension, compare the assembly information set in advance with the current assembly information of the virtual object in the virtual scene, to obtain a comparison result, and use the comparison result as a detection result for the detection item.

In an aspect, the second display module is further configured to: for the current detection dimension, display, in the assembly detection interface, the detection dimension identifier of the current detection dimension, and a detection item identifier of each detection item in the current detection dimension; and
when there is an abnormal detection item in detection items, display a detection item identifier of the abnormal detection item by using a fourth style, and display a detection item identifier of a normal detection item in the detection items by using a fifth style, where the fourth style is different from the fifth style.

According to the foregoing aspect of this disclosure, when a user triggers the detection instruction based on the one-tap detection control, one-tap detection on a plurality of detection items of the virtual object in a plurality of detection dimensions may be implemented. Compared with a complex detection procedure in the related art, in this aspect of this disclosure, detection efficiency of the assembly of the virtual object in the virtual scene is improved, and utilization of a hardware processing resource and a display resource of a device is improved. Because the detection of the assembly is performed dimension by dimension, and the detection result of each detection item of the virtual object in each detection dimension can be synchronously displayed in the process of assembly detection, the user can clearly learn of each detection item in the detection process. Because the display of the detection result of each detection item is not performed after the detection of all detection items is completed, but is displayed synchronously along with the execution of the detection, the user can feel the progress of the assembly detection, thereby improving a sense of control of the user over the assembly detection.

An aspect of this disclosure further provides an electronic device. The electronic device includes:
a memory, configured to store computer-executable instructions; and
a processor, configured to implement a data processing method in a virtual scene provided in embodiments of this application by executing the computer-executable instructions stored in the memory.

An aspect of this disclosure further provides a computer program product or a computer program. The computer program product or the computer program includes computer-executable instructions. The computer-executable instructions are stored in a computer-readable storage medium. A processor of a computer device reads the computer-executable instructions from the computer-readable storage medium. The processor executes the computer-executable instructions, so that the computer device performs a data processing method in a virtual scene provided in embodiments of this application.

An aspect of this disclosure further provides a non-transitory computer-readable storage medium, having computer-executable instructions stored therein, the computer-executable instructions, when executed by a processor, implementing a data processing method in a virtual scene provided in embodiments of this application.

In an aspect, the computer-readable storage medium may be a memory such as a read-only memory (ROM), a random access memory (RAM), an erasable programmable read-only memory (EPROM), an electrically erasable programmable read-only memory (EEPROM), a flash, a magnetic surface memory, an optical disc, or a CD-ROM; or may be various devices including one or any combination of the foregoing memories.

In an aspect, executable instructions may be in a form of programs, software, software modules, scripts, or codes, and written in any form of a programming language (including a compiled language or an interpreted language, or a declarative language or a procedural language). In addition, the executable instructions may be deployed in any form, including being deployed as an independent program or as a module, a component, a subroutine, or another unit suitable for use in a computing environment.

For example, the executable instructions may but not necessarily correspond to files in a file system, may be stored in a part of a file that stores other programs or data, for example, stored in one or more scripts in a hyper text markup language (HTML) document, a single file dedicated to a program in question, or a plurality of cooperative files (for example, files that store one or more modules, subroutines, or codes).

For example, the executable instructions may be deployed to be executed on a computing device, or on a plurality of computing devices in a single place, or on a plurality of computing devices in a plurality of places and interconnected through a communication network.

The foregoing descriptions of this disclosure are not intended to limit the protection scope. The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive. Any modification, equivalent replacement, or improvement made without departing from the spirit and principle of this disclosure are to be fall within the protection scope of this disclosure.

What is claimed is:

1. A data processing method in a virtual scene, wherein the method comprises:
displaying, in a detection interface of a virtual scene, a detection control corresponding to a configuration of a virtual object, wherein the configuration of the virtual object includes at least two detection categories, and each detection category includes at least one detection item;
detecting the configuration of the virtual object in the detection categories when a detection instruction is triggered based on the detection control;
displaying progress indication information of the configuration of the virtual object, wherein the progress indication information is configured to indicate progress of detecting the configuration of the virtual object in each detection category; and
displaying a detection result of each detection item of the virtual object.

2. The method according to claim 1, the method further comprises:
displaying a progress indicator, wherein the progress indicator includes category identifiers of the detection category categories that are sequentially arranged;
displaying, in a first style, a category identifier of a detection category in which the configuration detection has been completed;
displaying, in a second style, a category identifier of a current detection category; and
displaying, in a third style, a category identifier of a detection category in which the configuration detection has not been completed.

3. The method according claim 1, the method further comprises:
receiving the detection instruction in response to a tap operation for the detection control; and
displaying a configuration modification control, wherein the configuration modification control is configured to modify the configuration of the virtual object.

4. The method according to claim 3, the method further comprises:
displaying, in response to a triggering operation for the configuration modification control, a setting interface corresponding to an abnormal detection item in a first detection category.

5. The method according to claim 4, the method further comprises:
closing the setting interface in response to a set completion instruction triggered based on the setting interface, and continuing to detect the configuration of the virtual object.

6. The method according to claim 4, the method further comprises:
displaying, in response to a set completion instruction based on the setting interface, a category detection interface with a determining control corresponding to a second detection category; and
displaying, when a triggering operation for the determining control is received, a configuration detection interface that corresponds to a third detection category.

7. The method according to claim 4, the method further comprises:
displaying, in the setting interface, a setting result obtained by performing the configuration information corresponding to the abnormal detection item, and a setting control corresponding to the abnormal detection item, wherein
the setting control is configured to adjust the setting result.

8. The method according to claim 4, the method further comprises:
displaying, based on rankings of the abnormal detection items in the detection result, setting interfaces corresponding to the abnormal detection items.

9. The method according to claim 1, the method further comprises:
detecting the configuration of the virtual object in the detection categories in a process of performing a pressing operation; and
pausing, when the pressing operation is released during the detection, the detection.

10. The method according to claim 9, the method further comprises:
displaying a detection guidance, wherein the detection guidance is configured to guide execution of the pressing operation.

11. The method according to claim 9, the method further comprises:
when the detection result indicates at least one abnormal detection item in the configuration of the virtual object, automatically displaying a setting interface corresponding to the at least one abnormal detection item.

12. The method according to claim 1, the method further comprises:
displaying a detection setting interface, the detection setting interface includes setting option of the virtual object.

13. An apparatus for data processing of a virtual scene, the apparatus comprising:
processing circuitry configured to:
display a detection control corresponding to configuration of a virtual object in a configuration detection interface of a virtual scene, wherein the configuration of the virtual object includes at least two detection categories, and each detection category includes at least one detection item;
detect the configuration of the virtual object in the detection categories when a detection instruction is triggered based on the detection control;
display progress indication information of the configuration of the virtual object, wherein the progress indication information is configured to indicate progress of detecting the configuration of the virtual object in each detection category; and
display a detection result of each detection item of the virtual object.

14. The apparatus according to claim 13, the processing circuitry configured to:
display a progress indicator, wherein the progress indicator includes category identifiers of the detection categories that are sequentially arranged;
display the category identifier of a detection category in which the configuration detection has been completed in a first style;
display the category identifier of a current detection category in a second style; and
display the category identifier of a detection category in which the configuration detection has not been completed in a third style.

15. The apparatus according to claim 13, the processing circuitry configured to:
receive the detection instruction in response to a tap operation for the detection control; and
display a configuration modification control, wherein the configuration modification control is configured to modify the configuration of the virtual object.

16. The apparatus according to claim 15, the processing circuitry configured to:
display a setting interface corresponding to an abnormal detection item in a first detection category in response to a triggering operation for the configuration modification control.

17. A non-transitory computer-readable storage medium, storing instructions which when executed by a processor cause the processor to perform:
displaying, in a configuration detection interface of a virtual scene, a detection control corresponding to configuration of a virtual object, wherein the configuration of the virtual object includes at least two detection categories, and each detection category includes at least one detection item;
detecting the configuration of the virtual object in the detection categories when a detection instruction is triggered based on the detection control;
displaying progress indication information of the configuration of the virtual object, wherein the progress indication information is configured to indicate progress of detecting the configuration of the virtual object in each detection category; and
displaying a detection result of each detection item of the virtual object.

18. The non-transitory computer-readable storage medium according to claim 17, wherein the instructions when executed by the processor further cause the processor to perform:
displaying a progress indicator, wherein the progress indicator includes category identifiers of the detection categories that are sequentially arranged;
displaying, in a first style, the category identifier of a detection category in which the configuration detection has been completed;
displaying, in a second style, the category identifier of a current detection category; and
displaying, in a third style, the category identifier of a detection category in which the configuration detection has not been completed.

19. The non-transitory computer-readable storage medium according to claim 17, wherein the instructions when executed by the processor further cause the processor to perform:
receiving the detection instruction in response to a tap operation for the detection control; and
displaying a configuration modification control, wherein the configuration modification control is configured to modify the configuration of the virtual object.

20. The non-transitory computer-readable storage medium according to claim 19, wherein the instructions when executed by the processor further cause the processor to perform:
displaying, in response to a triggering operation for the configuration modification control, a setting interface corresponding to an abnormal detection item in a first detection category.
